(19) United States
(12) Patent Application Publication
(10) Pub. No.: US 2007/0079545 A1
(43) Pub. Date: Apr. 12, 2007

(54) DRY POWDER FORMULATION FOR LOW-TOXICITY INSECT BAIT

(76) Inventors: ROBERT E. MCMANUS, Nokomis, FL (US); KENNETH KUPFER, Nokomis, FL (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/537,772

(22) Filed: Oct. 2, 2006

Related U.S. Application Data
(60) Provisional application No. 60/724,434, filed on Oct. 7, 2005.

(51) Int. Cl. A01M 1/20

(52) U.S. Cl. 43/131

(57) ABSTRACT

Disclosed are low-toxicity insect baits in dry powdery formulation and a method wherein the insect bait compound is designed, manufactured, packaged, shipped and otherwise handled in a dry powdery bait composition form prior to being mixed and dissolved in water or other solvent, without precipitate, by agricultural growers or other end users to produce a low-toxicity, liquid insect bait effective for utilization in the Liquid Gravity Feed Elimination System, LGFAES, or any equivalent device, so as to increase the effectiveness of the bait and reduce the cost otherwise associated with the packaging and shipping of baits in liquid form. The dry powdery baits within the present invention include attractants, insect-killing agents, preservatives, and adjuvants.

### RELATED APPLICATION

This application claims priority of U.S. Provisional Patent Application Ser. No. 60/724,434 filed Oct. 7, 2005, which is incorporated herein by reference.

### FIELD OF THE INVENTION

This invention relates to the field of pest control, and more particularly to an insect bait compound that can be designed, manufactured, packaged, shipped and otherwise handled in a dry powdery form prior to being dissolved with water or other solvent by agricultural growers or other end users for utilization by them in low-toxicity, liquid insect bait station dispensers; thus greatly reducing the bait's volume and weight and related cost to produce and handle it prior to final use, and otherwise improving the effectiveness of the bait.

### BACKGROUND OF THE INVENTION

Applicants of the instant application have previously described a low-toxicity liquid insect bait used in cooperation with the Liquid Gravity Feed Elimination System (LGFAES) detailed in U.S. Pat. No. 6,467,216 B2, issued Oct. 22, 2002, to eliminate several problem-causing ants and numerous other carbohydrate and protein-feeding insect species.

The LGFAES Station Dispenser, with its weather-sheltering, long-term delivery attributes, permits the use of slow-acting, low-toxicity liquid baits whereby the foraging ants after consuming the bait return to feed and thereby eliminate the queen and the total colony. In addition, since the liquid bait is stored and provided to the feeding insects entirely within the dispenser, this colony elimination is accomplished in a bio-friendly manner. Alternate delivery systems using quick-acting, high-toxicity baits kill the foraging ants prior to returning to the nest, consequently alarming the colony and causing them to relocate and increase in population. In addition, their broadcast delivery of bait contributes to the contamination of the environment.

An embodiment of the low-toxicity bait compound being discovered and claimed is comprised of a borate such as disodium octoborate, growth inhibitors, mating disruptors, pathogens or other active ingredients, that when in the diluted liquid bait form, is at a ratio of 1% or less toxicant by percentage weight to the finished bait total volume. The bait concentrate is placed in solution when diluted with water or other solvent such as fruit juices and other flavored drinks; and also is comprised of carbohydrates (sugars), such as glucose, fructose, maltose and sucrose; proteins, or combinations of amino acids in varying amounts; or other attractants adaptable to multiple insect species. Sodium benzoate, citric acid or other preservatives will be present in varying amounts to inhibit bait degradation and bacteria growth. An adjuvant such as a trail pheromone or sex pheromone is added to enhance the effectiveness of the active ingredient and or the attractant and otherwise assist placing said bait ingredients into solution without precipitate reducing the amount of required solid materials, thus improving solubility of the formulated powdery compound and assuring a proper flow within the Liquid Gravity Feed Elimination System (LGFAES) dispenser or similar device.

In agriculture for example, Argentine ants, now well established in California and parts of the southern United States, are major economic pests because they cultivate and protect homopterans (crop piercing, sucking and chewing insects) from predators and parasites. The symbiotic relationship between the Argentine ants and the homopterans has caused both populations to thrive. Also, Red Imported fire ants, spread throughout the southern United States are currently infesting over 320 million acres (reference: U.S. Department of Agriculture, Animal and Plant Health Inspection Service Dec. 07, 2004). Imported fire ants are aggressive in nature, destroy crops and wildlife costing hundreds of millions of dollars in damage, annually. Their sting can cause hypersensitivity reactions, including sometimes death as well as infections and scarring.

A current problem with existing liquid baits relates directly to the cost to manufacture, ship and handle them. Approximately 90% to 98% of the total volume and weight of these baits consists of water or other solvents. The insect bait composition and method of delivery being discovered and claimed is comprised of formulated powdery compounds that can be packaged and delivered to the end user in a completely dry powdery form, thus greatly reducing the volume and weight of the bait prior to its receipt by the end user. The bait concentrate is mixed with and dissolved in water or other solvents by the end user to produce the finished, low-toxicity liquid insect bait solution, without precipitate, and ready for use in the LGFAES or similar station dispensers.

It is desirable, particularly in agriculture where large quantities of bait are required, to provide such a bait concentrate with the resulting savings in space, weight and cost. The bait's concentrated form is consistent with this environment's accustomed practice of mixing of such powders in the use of fertilizer, herbicides and pesticides, and therefore accommodates these low-toxicity insect bait compounds being discovered.

### DESCRIPTION OF PRIOR ART

U.S. Pat. No. 6,916,469 discloses a gellable ant bait matrix comprising protein, carbohydrate, fat, and sterol as ant-preferred nutrients and uric acid as a bait-enhancing agent. The gellable matrix offers the benefit of its ability to apply the bait in cracks and areas not normally accessible to ant baiting systems. Methods of making ant-preferred matrices of this reference are also provided comprising mixing the various components to form a food.

U.S. Pat. No. 5,928,634 discloses a liquid bait for target insects and methods of attracting or controlling insects by means of its use. This reference specifically discloses the addition of sorbitol as a humectant to retard the drying of the liquid bait. The liquid bait further includes at least one insect attractant which is selected from the group consisting of sucrose, fructose, d-maltose, the lithium salt of saccharin, lithium chloride, and vitamins.

U.S. Pat. No. 5,939,061 discloses an attractant composition for the control of multiple species of pest arthropods, particularly multiple species of pest ants. The composition, which includes a sugar and a salt for base, and water, attracts both oil-loving and sweet-loving ants and is especially useful with water soluble or suspendable toxicants.

U.S. Pat. No. 5,871,780 discloses a pest-controlling composition comprising a borate compound and a compound resulting in elevated concentrations of cyclic AMP, such as a phosphodiesterase enzyme inhibitor, or a formamidine. The borate compound of the pest-controlling composition has increased toxicity as compared to a borate compound acting alone.

In view of the foregoing, the prior art provides various compositions for pest control, more specifically for eliminating ants in an outdoor or indoor environment. These pest-controlling compositions are either in the form of a liquid or a gellable matrix, therefore water or other solvent is a necessary component of these compositions. Although a liquid, or semi-liquid composition proves to be practical in the administration and distribution of a pest-controlling process, the addition of water into the original formula of these pest-control baits adds the unnecessary weight and hence more cost associated with the packaging and shipping of the liquid baits.

It is desirable, therefore, to provide a pest-controlling composition that is in a dry power formula. The composition is ready to be dissolved in water or other solvent upon use by an end user.

### SUMMARY OF THE INVENTION

According to the present invention, there is provided an insect-controlling composition comprising a low-toxicity, bio-friendly, insect-killing active ingredient, an attractant, a preservative, and an adjuvant.

It is an object of the present invention to provide the insect-controlling composition as a dry powder formula.

It is another object of the present invention to provide a method wherein a low-toxicity, insect-controlling composition can be designed manufactured, packaged, shipped and otherwise handled in a dry powdery form prior to be completely dissolved with water or other solvent by agricultural growers or other end users as means to greatly reduce the bait's volume and weight and related cost to produce and handle prior to its final use.

It is another objective of the present invention to provide the insect-controlling composition that is compatible to be used in concert with the low-toxicity, bio-friendly, Liquid Gravity Feed Elimination System (LGFAES).

These and other objects become apparent from the following description of preferred embodiments taken together with the appended claims.

### DETAILED DESCRIPTION OF THE INVENTION

As used herein, the terms “bait” and “attractant” mean any substances that entice an insect to ingest that substance alone, or combined with one or more other substances, including an insect toxicant or other active ingredient.

As used herein, the term “growth inhibitor” means any of the endogenous or exogenous substances which inhibit the normal growth of animals, insects, plants, fungi, or their tissues, or the growth of microorganisms.

As used herein the term “pathogen” means a biological agent that causes disease or illness to its host. A pathogen may be a virus, a bacteria, a plague, or the like.

The present invention is described as a method and formulation for producing and delivery for use by the growers or other end user of a low-toxicity, bio-friendly, insecticidal bait for controlling ants. However, it should be appreciated that it is contemplated that the present invention could, potentially, be effective in controlling many other crawling, walking, or flying insect pests.

Currently there exists a need to reduce the cost and labor associated with the manufacture, shipping, and storage of insect-controlling baits in a liquid form. Approximately 90-98% of the total volume and weight of these liquids baits is that of water or inactive solvents. The insect bait composition in the present invention is that of a dry power formulation that can be packaged and delivered to the end user in smaller and lighter packages. The dry powder feature of the present invention is particularly useful in agriculture where large quantities of bait are required.

In one embodiment, the bait composition in the present invention comprises a borate component which is at a ratio of 1% or less by percentage weight to the final bait liquid volume. The borate component is selected from the group of active ingredients including disodium octoborate, growth inhibitors, mating disruptors, pathogens or any combination thereof. The bait composition further comprises a combination of attractants, preservatives, and adjuvants. The attractants include carbohydrates, proteins and/or amino acids, or any combinations thereof. The preservatives include, but are not limited to, sodium benzoate, and citric acid. The preservatives are present in various amounts to inhibit bait degradation and bacteria growth. The adjuvant assists in increasing the effectiveness of the active ingredient and the attractant, and aids in placing all of the above ingredients in solution with little or no precipitation so as to improve solubility of the bait composition.

The bait composition within the present invention is exclusive of any liquid component such as water. More specifically, the bait composition is presented with a dry powder formulation. The bait composition within the present invention is neither a gel matrix nor a liquid.

The bait composition is formulated as a bait concentrate. When mixed with and dissolved in water or other solvents, the bait concentrate changes into a liquid bait suitable for use in the low-toxicity, LGFAES dispenser system or equivalent.

The bait with its composition claimed herein in the present invention takes the form of powdery material.

Several benefits are obtained by lowering the borate compound concentration needed to control the pests. Among these benefits are the reduction and or the elimination of bait avoidance. Ant bait having a borate component at a concentration more than 1% causes the ant to go into stress, relocate and then increase in population. Moreover, the low toxicity of the insect controlling composition reduces the risk of polluting the environment.

Within the bait composition is the inclusion of an attractant. The attractant comprises a plurality of sugars and or proteins, or a combination of amino acids. The plurality of amino acids has a concentration of about 2-7 /g 100 ml of the bait. The sugar is a sucrose, a fructose, a glucose, a maltose, a trehalse, and has a concentration of about 20-60 g/100 ml of the bait.

In another preferred embodiment, the bait composition within the present invention is applicable to be used with the LGFAES Station Dispenser (U.S. Pat. No. 6,467,216). The LGFAES dispenser provides a low-maintenance, weather-resistant ant elimination system via a practical, safe mechanical liquid delivery platform designed for use with a low-toxic liquid insect bait. The LGFAES dispenses a controlled amount of low toxic liquid bait from an air-restricted reservoir over an extensive period of time so as to reduce liquid bait degradation due bacteria growth, dead insect and plant contamination and loss due to evaporation. With the combined application of the LGFAES Station Dispenser and the bait within the present invention, the queen ants and the total colony are eliminated after the foraging ants consume the bait and in turn, feed the balance of the colony. In addition, since the liquid bait stored and provided to the foraging ants is entirely within the Dispenser, the colony elimination is accomplished in a most bio-friendly manner.

The dry powdery bait is packaged into different sized containers depending on its application by the end user; for example, in the control of problem ants in agriculture, the bait is sold in 25 pound packages for use by growers to dilute with water or other solvent in 55 gallon drums, centrally, for subsequent decanting into individual 32 ounce or 16 ounce bait bottles to be taken into the field to switch out the empty bait bottles then attached in place with the Liquid Gravity Feed Ant Elimination Device as described in U.S. Patent Application No. 11/241,194, dated Sep. 30, 2005, and except in the initial ant knock-down stages, the 16 ounces bottle provides bait for two to three months or more without replenishment.

The following are examples of the dry powdery bait composition of the present invention.

### EXAMPLE 1

A dry powdery bait composition comprises the following ingredients by percentage weight to total volume:
1% disodium octoborate;
12.5% fructose and 12.5% sucrose as an attractant;
0.1% sodium benzoate as a preservative; and
a trail pheromone of the targeted insect as an adjuvant.

### EXAMPLE 2

A dry powdery bait composition comprises the following ingredients by percentage weight to total volume:
0.5% disodium octoborate;
12.5% fructose and 12.5% sucrose as an attractant;
0.3% sodium benzoate as a preservative; and
a sex pheromone of the targeted insect as an adjuvant.

It should be apparent that the present invention provides a method of producing and delivering powdered bait to an end user; that can be dissolved by the end user to produce a low-toxicity, bio-friendly, insect bait that can be used in the LGFAES liquid bait station dispenser, or equivalent. Most liquid ant baits now sold are highly toxic mixture such as Andro, Terro (5.4% boric acid), or the like, that are used for the quick kill of the foraging ants, and are not designed to destroy the entire colony. The bait as presently disclosed is without precipitate so as not to interrupt the LGFARES dispensing action. And it also includes preservative that inhibits bait degradation and bacteria growth.

While the foregoing description provides specific embodiments of the present invention, it should be appreciated that these embodiments are described for the purposes of illustration only, and that numerous alterations and modifications may be practiced by those skilled in the art without departing from the spirit and scope of the invention. It is intended that all such modifications and alterations be included insofar as they come within the scope of the invention as claimed or the equivalent thereof.

1. An insect bait in the form of dry powder, comprising:
an insect-killing agent,
an attractant,
a preservative, and
an adjuvant.

2. The insect bait of claim 1, wherein said insect-killing agent comprises a borate, a growth inhibitor, a mating disrupter, a pathogen, or any combination thereof.

3. The insect bait of claim 1, wherein said insect-killing agent is disodium octoborate in a concentration range of 0.5% to 1% by percentage weight to total volume.

4. The insect bait of claim 1, wherein said attractant comprises a glucose, a fructose, a maltose, a sucrose, a protein, an amino acid, or any combination thereof.

5. The insect bait of claim 1, wherein said attractant consists of 12.5% fructose and 12.5% sucrose by percentage weight to total volume.

6. The insect bait of claim 1, wherein said preservative comprises a sodium benzoate, a citric acid or any combination thereof.

7. The insect bait of claim 1, wherein said preservative is sodium benzoate in the range of 0.1% to 0.3% by percentage weight to total volume.

8. The insect bait of claim 1, wherein said adjuvant is a trail pheromone or a sex pheromone.

9. A method comprising the steps:
a) providing an low toxity insect bait in a dry powdery form;
b) packaging and shipping the insect bait in a dry powdery bait to the point of use;
c) mixing and dissolving the insect bait in water or other solvent, without precipitate at the point of use for use in a bait station dispenser.

10. The method as defined in claim 9 and in which dispenser is a Liquid Gravity Feed Elimination System.
